(19) United States
(12) Patent Application Publication
(10) Pub. No.: US 2010/0081005 A1
(43) Pub. Date: Apr. 1, 2010

(54) Friction Stir Welding Tool and Weld Metal Structure with Plural Onion Rings

(76) Inventors: Jong-Ning AOH, Chiayi County (TW); An-Cheng Yen, Taichung City (TW); Tony Tang, Taichung City (TW); Ming-Tang Dong, Taichung City (TW); Bob Hwang, Taichung City (TW); Jin-Fa Huang, Tainan City (TW); Pai-Chen Lin, Chiayi County (TW)

Correspondence Address: Dr. BANGER SHIA, 102 Lindencrest Ct., Sugar Land, TX, 77479-5201, US

(21) Appl. No.: 12/611,889

(22) Filed: Nov. 3, 2009

Related U.S. Application Data
(63) Continuation-in-part of application No. 12/238,841, filed on Sep. 26, 2008.

(51) Int. Cl. B32B 15/01; B23K 20/12

(52) U.S. Cl. 428/615; 228/2.1

(57) ABSTRACT

A friction stir welding tool and weld metal structure with plural onion rings, in which the tool is formed on the tool head with three surfaces, which are connected to one another through three spaced surfaces. An eccentrical axis of the tool head deviates from a central axis of the tool handle. One of the three surfaces is a deviation cutting surface which is a flat surface formed by cutting off a wall thickness from one side of an outer peripheral surface of the tool head toward the central axis of the tool handle. Each of the three spaced surfaces is alternately formed with plural notches and plural protrusions. The above welding tool is used to perform a stir friction welding operation to two metals to form the weld metal structure with the same number of onion rings as the protrusions and notches of each of the spaced surfaces.

This application is a continuation of part of U.S. patent application Ser. No. 12/238,841, which claims the benefit of the earlier filing date of Sep. 26, 2008. Claim 1 of this application is added with a new limitation than the previous Claim 1 of the U.S. patent application Ser. No. 12/238,841, Claim 2 of this application is added with a new limitation that the previous claim 2 of the U.S. patent application Ser. No. 12/238,841. Claims 3-5 of this application are the same as the previous claims 3-5 of the U.S. patent application Ser. No. 12/238,841, Claims 6-7 of this application are new, and Claim 8 of this application is revised from the previous claim 6 of the U.S. patent application Ser. No. 12/238,841.

### BACKGROUND OF THE INVENTION

1. Field of the Invention

The present invention relates to a friction stir welding technology, and more particularly to a friction stir welding tool and a weld metal structure with plural onion rings.

2. Description of the Prior Art

The friction stir welding technology is well-known for welding two metals together. The friction stir welding technology issued by the welding institute in 1991 and the technology disclosed in JP Patent No. 2712838, entitled with “improvements relating to friction welding”, both interpose a high-speed rotating tool between two combined metals and utilize the heat generated by the friction between the high-speed rotating tool and the two metals to reduce the yield strength of the portions of the two metals in contact with the tool head and keep the to-be-welded portions of the metals in a low-strength state, and then utilize the tool head to stir the yield-strength-reduced portions of the two metals, after cooling, the two metals will gradually regain their yield strength, and thus they are integrally welded.

The head of the friction stir welding tool in the above technologies is commonly in the form of a round cylinder to stir and mix the metals only in horizontal direction when the two metals are subjected to the friction stir welding operation. Moreover, since the tool head is round, the phenomena that the tool head cannot substantially stir and mix the two metals is likely to occur, so that the two metals can only be jointed after cooling under the reduced yield strength condition, thus causing poor welding effect and reduced strength.

In addition, another technology such as JP Laid-Open Patent Application 10-249552, entitled with “friction welding method, device and welding tool”, was developed later, and the tool is commonly formed with a groove in the tool head, or as shown in FIG. 1, the tool head A is formed with a helical groove A1 with helical inclined surface A2 and connected with a shoulder B at the bottom thereof. As shown in FIG. 2, when the tool head A rotates in a clockwise direction to perform the friction stir welding operation to the two metals C1, C2, the frictional heat will reduce the yield strength of the corresponding portions of the two metals C1, C2. Further referring to FIG. 3, the tool head A utilizes the helical inclined surface A2 of the groove A1 to stir the portions of the two metals C1, C2, where the yield strength is reduced, so as to make the stirred portions of the two metals C1, C2 move upwards and mix with each other, and then the shoulder B will press the portions of the two metals C1, C2, which move upwards, to make them flow back between the two metals C1, C2 to weld the two metals C1, C2 to form a welding structure D shown in FIG. 4. The real state of the weld metal structure D is as shown in attachment 1. The weld metal structure comprises, in order from both ends to the middle: two unaffected base material zones D1, two heat affected zones D2 affected by the frictional heat of the tool head A, a recrystallization zone D3 capable of vertically moving and mixing, and a stirred zone D4. Under the action of the material backfill realized through the upward-stirring of the helical inclined surface A2 and the downward-pressing of the shoulder B, the stirred zone D4 is formed with an onion ring C3, thus the weld metal structure D can provide a substantial mixing effect. Moreover, the vertical mixing provides a sufficient backfill of the material flow, so that a defect-free stirred zone as well as a higher strength of the weld can be achieved under optimal welding condition.

After the above technology was put into practice for a certain period of time, it was found that if the tool head performs the friction stir welding operation vertically with respect to the two metals, the tool head is likely to fracture due to over-large resistance. According to this, another technology disclosed in Taiwan Patent No. 090121494, entitled with “friction stir welding method and apparatus and welding structure”, has been developed, and this technology makes the tool incline with respect to its moving direction at a certain angle, so as to make the tool head slantways perform the friction stir welding operation to the two metals, thus reducing the resistance acting on the tool head during processing operation to make the processing operation more smooth.

However, it can be found that the existing technology still suffers from the following problems. Since the tool head A, as shown in FIG. 1, is formed with a helical groove A1 which cannot extend to the distal end of the tool head A, if the tool head A is used to process the two metals C1, C2, the distal end of the tool head A can only stir and mix the two metals C1, C2 in the horizontal direction, and even the tip of the tool head A cannot provide any stirring operation yet due to insufficient diameter. If the two metals C1, C2 are vertically stirred and mixed to form the weld metal structure D, and the stirred zone D4 is formed with the onion ring C3, defect C4 is likely to form between the bottom of the weld metal structure D and the onion ring C3 since the material, which will be pressed and pushed back by the shoulder B, cannot be filled back in time due to too long moving path. Moreover, since the tool head A is formed in a conical shape, the horizontal stirring and mixing effect of the tool head A is still poor.

If the tool head A changes the rotation direction to rotate in a counterclockwise direction, the helical inclined surface A2 of the tool head A will drive the stirred portions of the two metals C1, C2 to move downwards, and the yield-strength-reduced portions of the two metals C1, C2 will be extruded to move upwards and mix with each other. When the two metals C1, C2 are welded to form the weld metal structure D, the onion ring C3 will still form within the stirred zone D4 of the weld metal structure D, and the portion of the weld metal structure D, which is extruded to move upwards, is also likely to cause the defect C4 shown in FIG. 6 since the material cannot be filled back in time.

If the defect C is to be avoided, it is necessary to adjust the rotation speed, the forward feeding speed, the length and many other variables of the tool head A, and after a laborious trial-and-error process, the formation of the defect C4 could be gradually reduced, yet, the defect might not be completely eliminated for certain plate thickness, thus wasting time, labor and material. According to this, the inventor of the present invention has developed a friction stir welding tool and a weld metal structure with plural onion rings from the aspect of eliminating the defect C4 and improving the horizontal stirring and mixing effect.

### SUMMARY OF THE INVENTION

The primary objective of the present invention is to provide a friction stir welding tool which can produce plural onion rings on a weld metal structure formed by welding two metals and improve the horizontal stirring and mixing effect to enhance the strength of the weld metal structure formed by the two metals and avoid the defect formation on the weld metal structure.

In order to achieve the above objectives, the tool of the present invention is in a conical shape, and the tool head is axially formed on an outer periphery thereof with three surfaces and three spaced surfaces, and the biggest one in the three surfaces is a deviation cutting surface, the central axis of the tool head deviates from the central axis of the tool handle to become eccentric, and the three surfaces and three spaced surfaces are alternately arranged in such a manner that the respective spaced surfaces are located between each pair of surfaces, the respective spaced surfaces are formed with plural notches and plural protrusions that are alternately arranged in an axial direction of the tool head. By such arrangements, the tool head can utilize the three surfaces to stir the metals to improve the mixing effect, and the protrusions of the spaced surfaces together with the notches will produce a local material flow to stir the metals to produce a corresponding number of onion rings, so as to shorten the material backfill path of the respective onion rings to avoid occurrence of defect in the stirred zone.

The secondary objective of the present invention is to provide a friction stir weld metal structure with plural onion rings which is formed by welding two metals in a friction stir welding manner. The weld metal structure is formed with plural onion rings in the stirred zone with the number corresponding to the number of the protrusions and notches of each spaced surface of the tool head. By such arrangements, on a single weld metal structure, with the increase of the number of the onion rings, the size of the respective onion rings is correspondingly reduced, thus shortening the material backfill path of the respective onion rings to avoid the occurrence of defect.

In order to achieve the above objective, a friction stir weld metal structure with plural onion rings is formed through a stir friction welding of two metals and comprises two recrystallization zones and a stirred zone that are successively arranged from both ends to a center thereof.

### BRIEF DESCRIPTION OF THE DRAWINGS

FIG. 1 is a perspective view of a conventional welding tool;

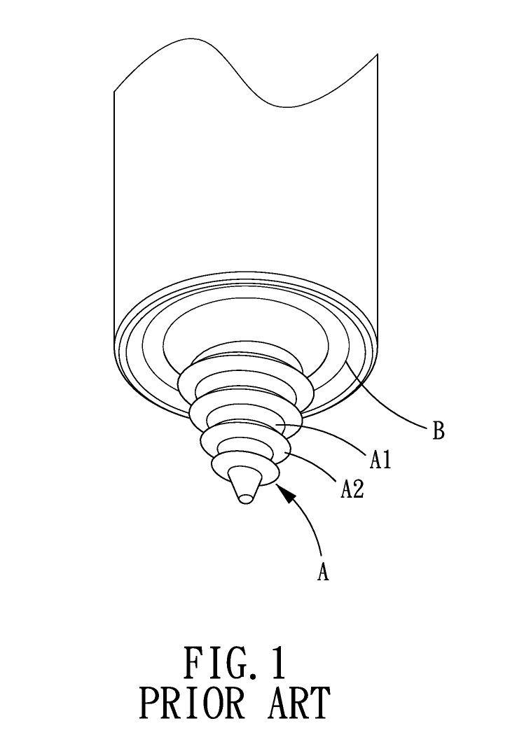

FIG. 2 is a schematic view illustrating that the conventional welding tool is performing a friction stir welding operation;

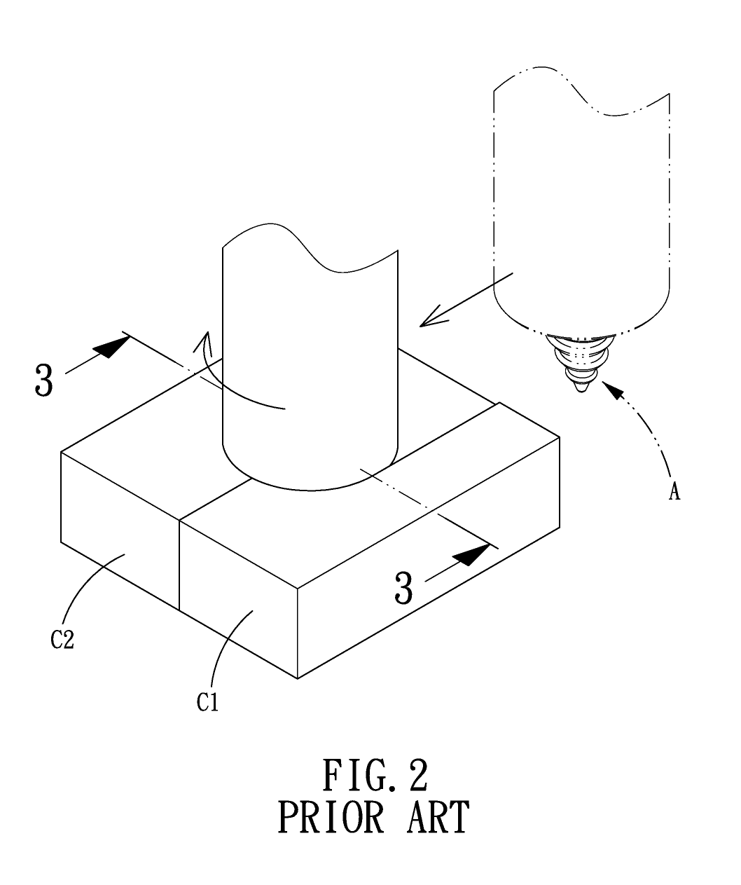

FIG. 3 is a cross-sectional view illustrating the conventional welding tool is performing the friction stir welding operation to two metals;

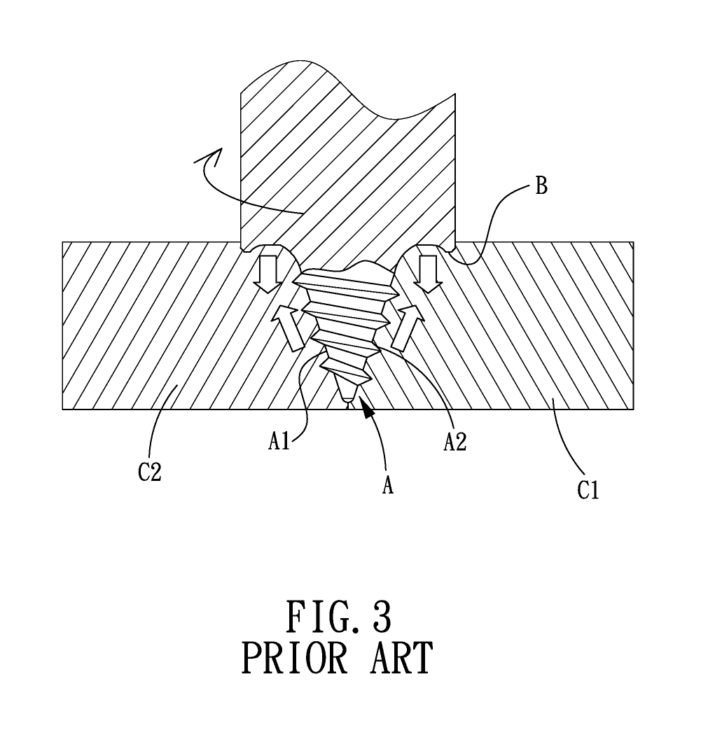

FIG. 4 is a schematic view of a conventional weld metal structure;

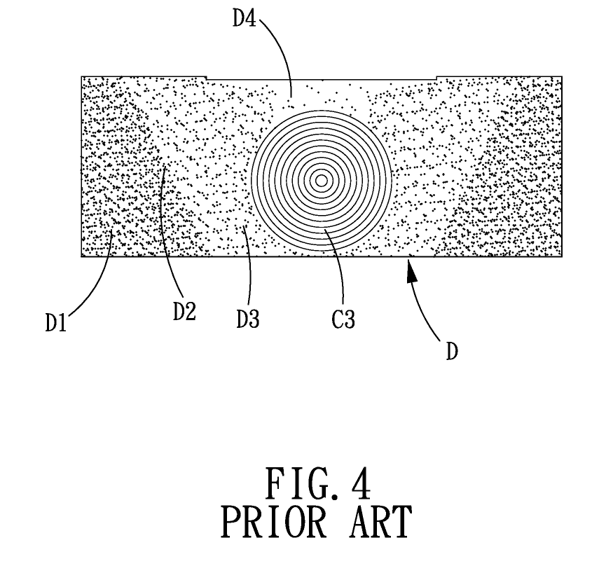

FIG. 5 is a schematic view of the conventional weld metal structure with defect caused during the clockwise rotation of the welding tool;

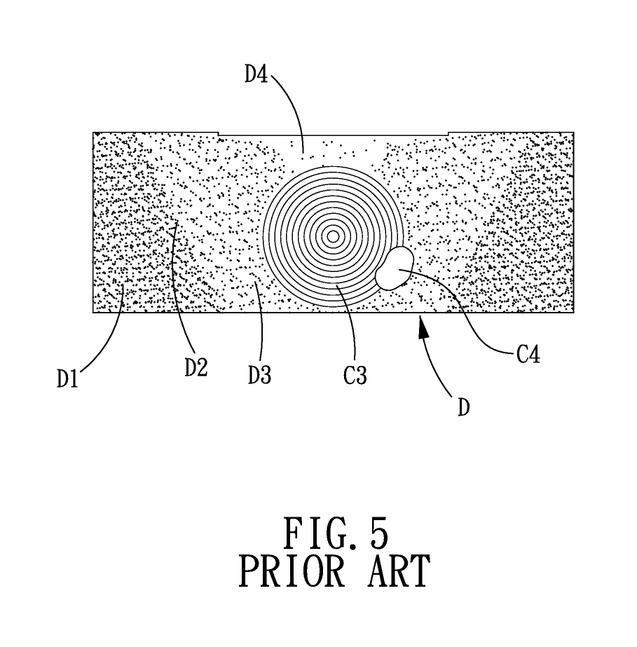

FIG. 6 is a schematic view of the conventional weld metal structure with defect caused during the counterclockwise rotation of the welding tool;

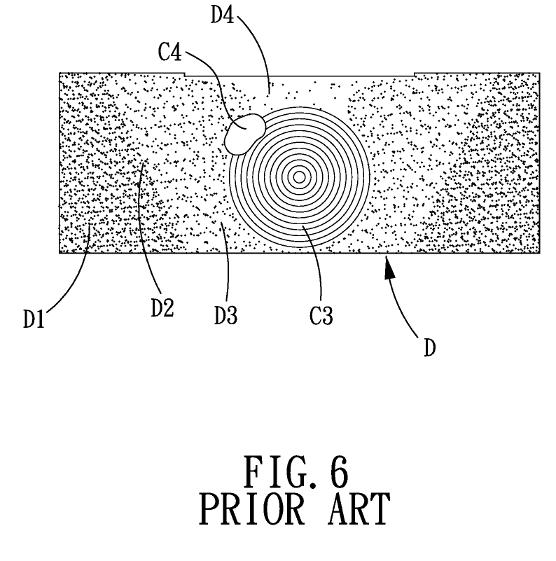

FIG. 7 is a perspective view of a friction stir welding tool in accordance with the present invention;

FIG. 8 is a side view of the friction stir welding tool in accordance with the present invention;

FIG. 9 is a bottom view of the friction stir welding tool in accordance with the present invention;

FIG. 10 is a schematic view of a friction stir weld metal structure with plural onion rings in accordance with the present invention;

FIG. 11 is a schematic view illustrating that the protrusions on the respective spaced surfaces are respectively located at a different height from the protrusions of another spaced surface and arranged at an inclined angle;

FIG. 12 is a schematic view illustrating the weld metal structure with plural onion rings formed by the welding tool of FIG. 11 in accordance with the present invention; and

FIG. 13 is a schematic view of another friction stir welding tool in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

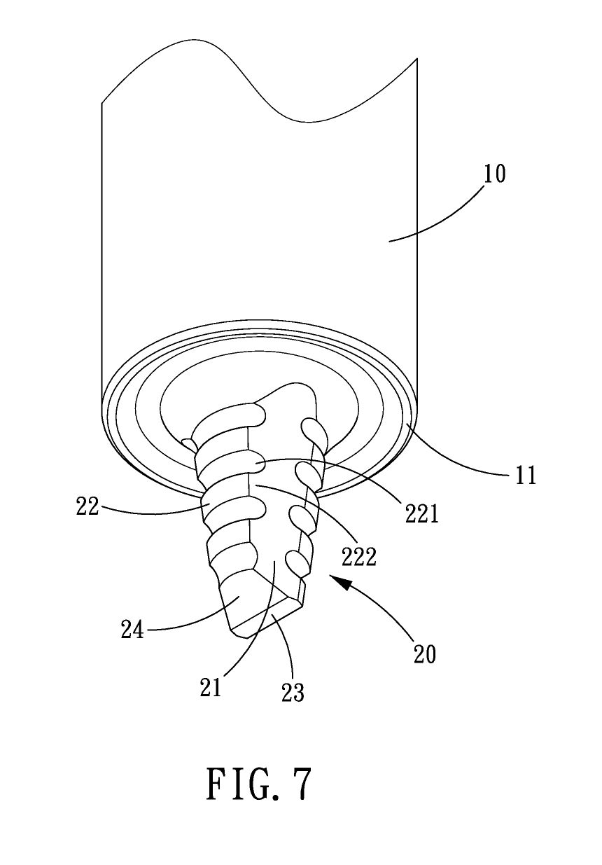

Referring to FIGS. 7-9, a friction stir welding tool in accordance with the present invention comprises a tool handle 10 and a tool head 20.

The tool handle 10 has one end formed with a shoulder 11 on a periphery thereof. The shoulder 11 is provided with an annular shoulder groove 110 around a central axis O of the tool handle 10, and a curved protruding shoulder connecting portion 111 at an inner side of the annular shoulder groove 110.

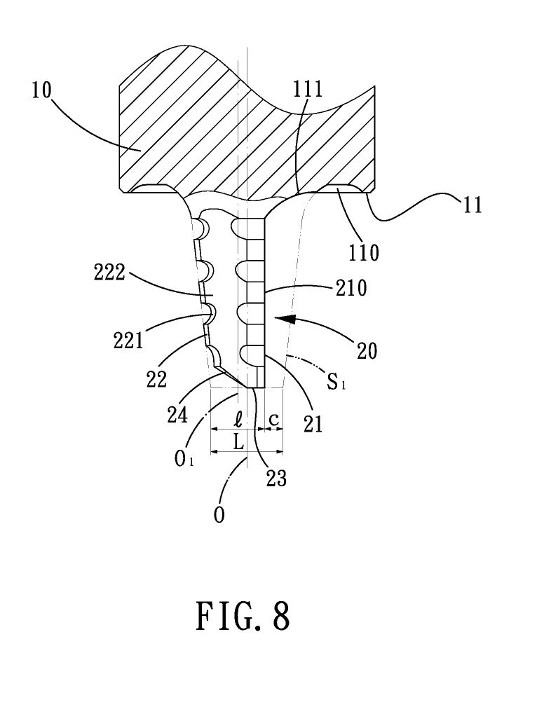

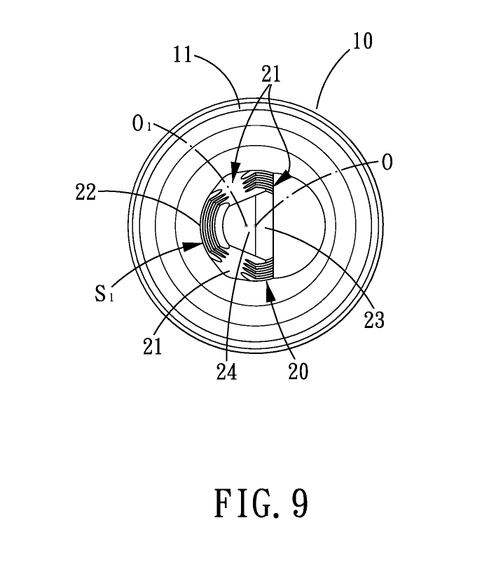

The tool head 20 is in a conical shape and formed at the end of the tool handle 10 and connected to the shoulder connecting portion 111. The tool head 20 has an eccentrical axis O1 deviating from the central axis O of the tool handle 10. The tool head 20 is axially formed on an outer periphery thereof with three surfaces 21 and three spaced surfaces 22. The biggest one of the three surfaces 21 of the tool head 20 is a deviation cutting surface 210 which is arranged adjacent the central axis O. The deviation cutting surface 210 is a flat surface formed by cutting off a wall thickness C from one side of an outer peripheral surface S1 of the tool head 20 toward the central axis O, as shown in FIGS. 8-9, the wall thickness 1 from the opposite side of the outer peripheral surface S1 toward the deviation cutting surface S plus the thickness C is the diameter L of the whole tool head 20, and the proportion of the wall thickness C to the diameter L is about 35-45%, so that the eccentrical axis O1 of the tool head 20 deviates from the central axis O to become eccentric. By such arrangements, when the tool handle 10 rotates around the central axis O, the tool head 20 will be eccentrically rotated around the central axis O to cause stir friction rather than pure rotation friction to the workpiece, namely, carrying out a stir friction welding.

The surfaces 21 and spaced surfaces 22 are alternately arranged in such a manner the respective spaced surfaces 22 are located between each pair of surfaces 21. The respective spaced surfaces 22 are formed with four arc-shaped notches 221 and four protrusions 222 that are alternately arranged in the axial direction of the tool head 20. The four protrusions 222 of the respective spaced surfaces 22 are respectively located at the same height as the four protrusions 222 of another spaced surface 22. The tool head 20 has an axially-tapered end with an end surface 23. One of the spaced surfaces 22 is formed with an inclined surface 24 extending to the end surface 23.

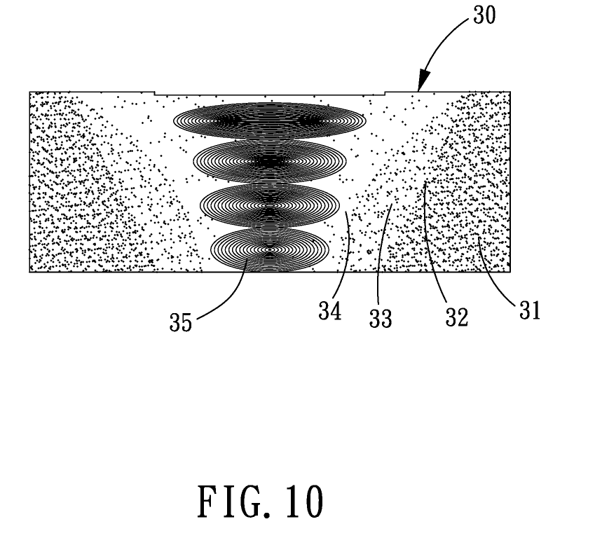

When the tool of the present invention performs the friction stir welding operation to two metals, the two metals can be weld to form, as shown in FIG. 10, a weld metal structure 30. The real state of the weld metal structure 30 is as shown in attachment 2. Referring to FIG. 10, the friction stir weld structure has two base material zones 31, two heat affected zones 32, two recrystallization zones 33, and a stirred zone 34 that are successively arranged from both ends to the center thereof, specifically, the weld metal structure 30 comprises two recrystallization zones 33 and a stirred zone 34. The stirred zone 34 has the same number of onion rings 35 as the notches 221 and the protrusions 222 of the respective spaced surfaces 22 of the tool head 20, namely has four onion rings 35 in the present embodiment.

When the tool of the present invention is used to weld the two metals to form the weld metal structure 30, the four protrusions 222 of the respective spaced surfaces 22 of the tool head 20 are used to stir the portions of the two metals, the yield strength of which has been reduced due to frictional heat. Since the tool head 20 is in the conical shape, the respective protrusions 222 incline with respect to the axis of the tool head 20, which can make the stirred portions move and mix both in the horizontal direction and the vertical direction. The shoulder 11 of the tool handle 10 is used to press and to confine the material back to form the respective onion rings 35. It can be found that the respective onion rings 35 are formed through the stirring of the protrusions 222 of the respective spaced surfaces 22 that are respectively located at the same heights as the protrusions 222 of another of the spaced surfaces 22. Since the conventional weld metal structure only has a single onion ring, the backfill path of the material could be too long up certain plate thickness, so that the material cannot be filled back in time, thus causing the defect. The tool of the present invention divides the material flow in the stirred zone into four portions to form four onion rings 35, so that the backfill path of the respective onion rings 35 is effectively shortened. As a result, the material can be filled back completely, thus avoiding the occurrence of defect.

When the tool head 20 stirs the stirred zone 34 of the weld metal structure 30, the three surfaces 21 can push the portions with reduced yield strength to move, so as to stir the stirred zone 34 of the weld metal structure 30 thoroughly, thus improving the stirring effect.

The respective spaced surfaces 22 between each pair of surfaces 21 are used to provide a certain thickness to maintain structure strength and avoid the fracture of the tool head 20 due to over-large resistance.

The notches 221 of the respective spaced surfaces 22 of the tool head 20 are not limited to the arc shape, and can also be formed in a square shape or cone shape to achieve the same effect.

In addition, the inclined surface 24 of the tool head 20 can stir the portions at the bottom of the weld metal structure 30 while pushing them downward to enable the portions at the bottom of the weld metal structure 30 to move vertically, thus improving welding effect.

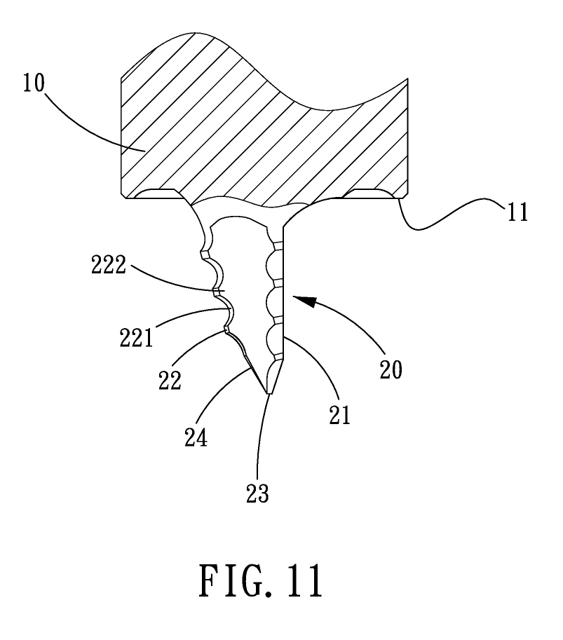

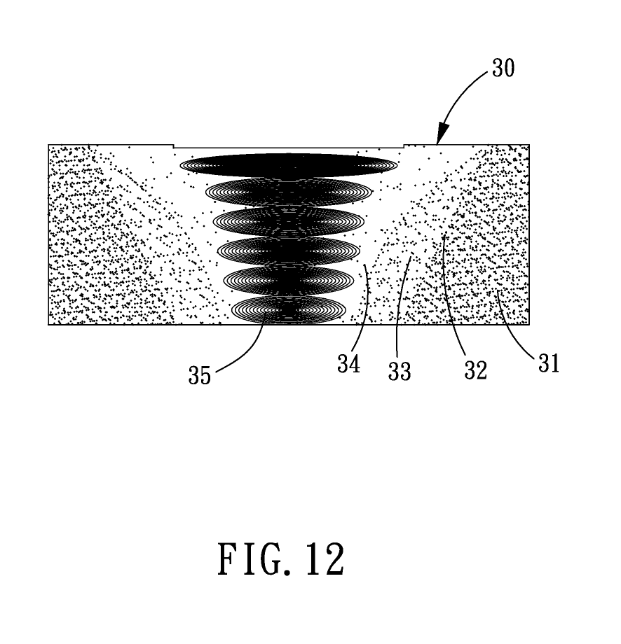

Referring to FIG. 11 illustrating a friction stir welding tool in accordance with another embodiment of the present invention, the protrusions 222 of the respective spaced surfaces 22 of the tool head 20 are respectively located at a different height from the protrusions 222 of another of the spaced surfaces 22, and the protrusions 222 of the respective spaced surfaces 22 are respectively arranged at an inclined angle with respect to the axis of the tool head 20, so as to weld the two metals to form the weld metal structure 30 as shown in FIG. 12. The real state of the weld metal structure 30 is as shown in attachment 3. It can be found that the onion ring 35 formed by the respective protrusions 222 of one of the spaced surfaces 22 is broken up by the respective protrusions 222 of another of the spaced surfaces 22, so that the number of the onion rings 35, which is originally four, will be more than four, such as six as shown in FIG. 12, or five, seven or more. The number of onion rings formed in the weld metal structure corresponds to the number of protrusions and notches on the welding tool. Moreover, since the respective protrusions 222 are respectively arranged at the inclined angle with respect to the axis of the tool head 20, the vertical stirring and mixing effect of the tool of the present invention can be improved.

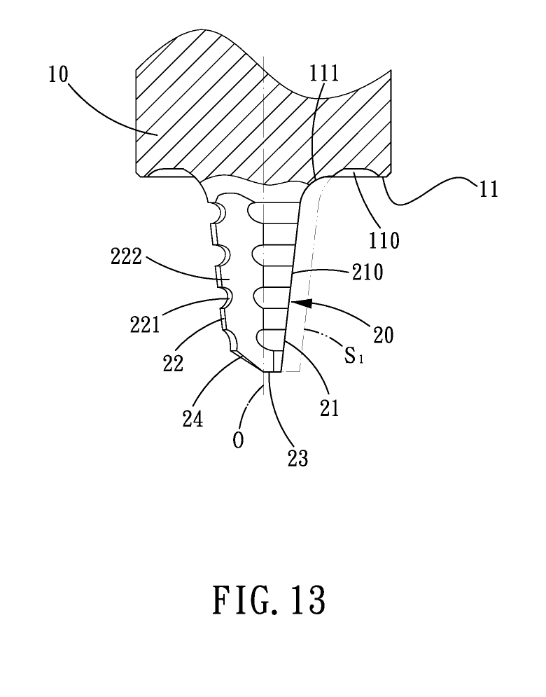

The deviation cutting surface 210 of the tool head 20 can be parallel to the central axis O of the tool handle 10 of the present invention as shown in FIGS. 8-10, or parallel to the outer peripheral surface S1, as shown in FIG. 13, that is to say, the deviation cutting surface 210 can be formed by directly cutting or grinding the tool head 20 along the slope of the outer peripheral surface Si toward the central axis O.

As known from the above-mentioned, the key technology of the present invention resides in the configurations of the respective surfaces 21, the respective protrusions 222 and the respective notches 221 formed on the tool head 20. As for the number of the surfaces 21, the protrusions 222 and the notches 221, it is not limited to the above-mentioned.

While we have shown and described various embodiments in accordance with the present invention, it is clear to those skilled in the art that further embodiments may be made without departing from the scope of the present invention.

What is claimed is:

1. A friction stir welding tool comprising:
a tool handle having one end formed with a shoulder on a periphery thereof, the tool handle including a central axis; and
a tool head being in a conical shape and formed at the end of the tool handle, the tool head having an eccentrical axis deviating from the central axis of the tool handle, the tool head being axially formed on an outer periphery thereof with three surfaces and three spaced surfaces, the three surfaces and three spaced surfaces being alternately arranged in such a manner the respective spaced surfaces are located between each pair of surfaces, the respective spaced surfaces being formed with plural notches and plural protrusions that are alternately arranged in an axial direction of the tool head.

2. The friction stir welding tool as claimed in claim 1, wherein the notches of the respective spaced surfaces are arc-shaped but not limited to arc-shaped.

3. The friction stir welding tool as claimed in claim 1, wherein the tool head has an axially-tapered end with an end surface, one of the spaced surfaces is formed with an inclined surface extending to the end surface of the axially-tapered end of the tool head.

4. The friction stir welding tool as claimed in claim 1, wherein the protrusions of the respective spaced surfaces are respectively located at the same height as the protrusions of another of the spaced surfaces.

5. The friction stir welding tool as claimed in claim 1, wherein the protrusions of the respective spaced surfaces of the tool head are respectively located at a different height from the protrusions of another of the spaced surfaces, and the protrusions of the respective spaced surfaces are respectively arranged at an inclined angle with respect to an axis of the tool head.

6. The friction stir welding tool as claimed in claim 1, wherein one of the three surfaces is a deviation cutting surface, the deviation cutting surface is a flat surface formed by cutting off a wall thickness from one side of an outer peripheral surface of the tool head toward the central axis of the tool handle.

7. The friction stir welding tool as claimed in claim 6, wherein the deviation cutting surface of the tool head is formed by cutting off the wall thickness from one side of the outer peripheral surface of the tool head toward the central axis of the tool handle, a proportion of the wall thickness to a diameter of the tool head ranges from 35% to 45%, so that the eccentrical axis of the tool head deviates from the central axis of the tool handle to become eccentric.

8. A friction stir weld metal structure with plural onion rings formed by the friction stir welding tool as claimed in claim 1 being formed through a stir friction welding of two metals and comprising two recrystallization zones and a stirred zone that are successively arranged from both ends to a center thereof, plural notches and plural protrusions of a tool head of the friction stir welding tool together with a deviation cutting surface of the tool head which has an eccentrical axis deviating from a central axis of a tool handle of the friction stir welding tool to make the stirred zone form plural onion rings corresponding to the protrusions and notches by friction welding operation.
